(19) United States
(12) Patent Application Publication
(10) Pub. No.: US 2009/0048854 A1
(43) Pub. Date: Feb. 19, 2009

(54) TRIP IDENTIFICATION AND RECORDING SYSTEMS

(76) Inventor: Tuukka Laitinen, Seattle, WA (US)

Correspondence Address: LAW OFFICE OF CHAD C. SOLIZ , LLC, 407 N. Lincoln Ave. Ste. 105, LOVELAND, CO, 80537, US

(21) Appl. No.: 11/840,186

(22) Filed: Aug. 16, 2007

(51) Int. Cl. G06Q 99/00; G01S 5/00; G11B 20/00; G05B 15/00

(52) U.S. Cl. 705/1; 700/83; 701/213

(57) ABSTRACT

Recording devices and methods are disclosed that allow a user to make a voice recording in association with a trip, such as a business trip driven in an automobile, while providing trip-specific control functionality of the recording. The current location of the user, corresponding in some embodiments to the location of the vehicle, is determined by a GPS sensor. The device may be operated on and off to record particular trips, for example business trips, that may also depend upon the further requirements of the user. Voice recording is also provided for recording and storing messages of the user that may relate to the trip. In some embodiments software is provided for loading upon a computer for communication of trip information and voice recording to a computer. The device may be powered by power adapters or other devices designed to provide mobile power to electronic devices, such as power adapters for inside a vehicle, or in some embodiments via USB connection to a device. The invention may be operated in various modes, recording all trip information or only selected trip information as well as voice recording. Once downloaded the trip information may be displayed with links to the voice recording, as well as other trip specific information such as internet links to maps, and text may be added to further describe trip information. In some embodiments, the invention is a media device providing for USB connectivity and may further be configured in a key format. Other functions and features are disclosed. Methods such as those corresponding to the devices are also disclosed, as are devices corresponding to the methods, as well as methods of doing business.

### BACKGROUND OF THE INVENTION

The present invention relates to trip identification and recording technology providing various functionality such as recording travel information including voice and location information utilizing removable and portable trip recording media.

Business travelers frequently have the need for travel via vehicles such as an individual car or other type vehicle in order to conduct their business, such as in the visitation of customers. As part of their business reporting, these travelers typically log their travel in terms of to and from locations, dates, purposes of travel, and distance in order to recoup their travel expenses, for tax reporting purposes, or for other purposes. Furthermore, the traveler may have need to identify information about the route, from starting point to final destination, and may therefore want to record travel information such as purpose of the trip and other such information.

Conventional automobile navigation systems provide travel position of a vehicle by the presentation of a map of the surroundings as part of a navigational system that incorporates traditional GPS (global positioning system) technology. These systems have provided display devices, user input and control, computer processing functionality, and the ability to save location information on storage media as part of a fairly bulky and complex navigation system of a vehicle. These technologies have traditionally provided the ability to record travel information including voice information, albeit in a complex and relatively fixed installation within the vehicle.

However, the aforementioned technology suffers at least from the complexity of requiring a full in-vehicle navigation system with processing capability to support the various functionality such as map display and data calculations for determining trip distances, directions, routes, as well as other data processing. The aforementioned technology also suffers from the lack of portability of the system and the relative expense of these systems. Finally, navigation systems generally suffer from the lack of portability of the functionality of the system. Wherein some traditional systems such as the technology in U.S. Pat. No. 6,941,224 describe some ability to download data to removable media, functionality of the system is not as portable. There has been a recognized and heretofore unmet need of the traveler to have the ability to record and store multiple types of travel information, particularly voice information with other travel information, without having to purchase, rent, borrow, carry or install a navigation system or to bring along a computer in association with navigation system technology, particularly when utilizing vehicles on a temporary basis or vehicles utilized only part-time for business, or otherwise having to use multiple separate technologies such as GPS units and voice recorders.

### SUMMARY OF THE INVENTION

Recording devices and methods are disclosed that allow a user to make a voice recording in association with travel, such as a business trip driven in a vehicle, while providing trip-specific control functionality of the recording. The current location of the user, corresponding in some embodiments to the location of the vehicle, is determined by a GPS sensor. The device may be operated on and off to record particular trips, for example business trips, that may also depend upon the further requirements of the user. Voice recording is also provided for recording and storing messages of the user that may relate to the trip.

The devices and methods may be used or performed in combination with a CPU or other processing means, such as a computer, wherein the device stores the information as data on storage media of the device. The information can be retrieved and used or executed by a CPU or computer. Examples of the information may be data recorded by the device and on to storage media of the device, as well as instructions that are stored on the media, including potentially software, program code, and firmware, as well as other instruction known to those skilled in the art that can be retrieved and executed by a processor. The storage media in some preferred embodiments may be a memory device or integrated circuit, such as flash memory, or other storage media consistent with the present invention. Instructions may be operational when executed by a processor to direct the processor to operate in accordance with the present invention.

In some embodiments software is provided for loading upon a computer for communication of trip information and voice recording to a computer. The device may also be powered by power adapters or other devices designed to provide mobile power to electronic devices, such as power adapters for inside a vehicle, or in some embodiments via USB connection to a device. The invention may be operated in various modes, recording all trip information or only selected trip information as well as voice recording.

Once downloaded the trip information may be displayed with links to the voice recording, as well as other trip specific information such as internet links to maps, and text may be added to further describe trip information. In some embodiments, the invention is a media device providing for USB connectivity and may further be configured in a key format. Another function may be provided wherein, in some embodiments, a same trip feature is performed. In some preferred embodiments, the invention will restart each instance the user stops the vehicle, wherein the device is not powered, and the user subsequently selects the “same trip” function to continue on the previous trip recording. Further functionality is provided wherein recording may be reset, allowing in some applications the user to reset recording for any reason, such as to record a new trip without stopping or powering off the device, and a new recording may be made including a new sounding recording.

Methods such as those corresponding to the devices are also disclosed, as are devices corresponding to the methods, as well as methods of doing business. Removable and portable trip recording media devices and methods are disclosed, having features not dependent upon a CPU or a navigational system in providing functionality for recording trip information, such as location information or voice information. In some preferred embodiments both location information and voice information may be recorded and stored, as well as control of the recording. Other features are the on and off functionality of the invention and further in association with the recording of voice information. In preferred embodiments the invention is not dependent upon the recording of way points of any particular route in recording location and voice information.

Furthermore, trip identification and recording devices and methods are disclosed, again having features not dependent upon a CPU or a navigational system in providing functionality for recording location or voice information, as well as in the display of trip information and with links to the voice recording, as well as other trip specific information such as internet links to maps and text that further describe trip information. In some preferred embodiments both voice information and location information may be recorded and stored, as well as control of the recording. Other features are the on and off functionality of the invention and further in association with the recording of voice information. In preferred embodiments the invention is not dependent upon the recording of way points of any particular route in recording location and voice information. Other features are disclosed as embodiments of the invention.

Methods of recording travel information are also disclosed, as well as methods of identifying recorded travel information, and methods of accounting and recording trip information.

### BRIEF DESCRIPTION OF THE DRAWINGS

FIG. 1 is a top view of an embodiment of the present invention.

FIG. 2 is a diagram of the device and method in accordance with an embodiment of the present invention.

FIG. 3 is a flowchart in accordance with an embodiment of the present invention.

### DETAILED DESCRIPTION OF PREFERRED EMBODIMENTS OF THE INVENTION

The present invention is described in preferred embodiments that at least address one or more inadequacies of the prior art, while further providing unique and innovative features not heretofore addressed. Accordingly, embodiments of the invention are shown and described in the figures, written description, and claims and throughout the disclosure of this application.

Travel information is recorded and stored by the present invention. Travel information is electronically stored information recorded as an aspect of the present invention and may comprise location information, such as positional data acquired by a GPS (global positioning system) recording element, as well as voice information, such as recorded voice or other sound data.

Also, as previously mentioned, the invention may be used or performed in combination with a CPU or other processing means, such as a computer, wherein the device stores the information as data on storage media of the device. The information can be retrieved and used or executed by a CPU or computer. Examples of the information may be data recorded by the device and on to storage media of the device, as well as instructions that are stored on the media, including potentially software, program code, and firmware, as well as other instruction known to those skilled in the art that can be retrieved and executed by a processor. The storage media in some preferred embodiments may be a memory device or integrated circuit, such as flash memory, or other storage media consistent with the present invention. Instructions may be operational when executed by a processor to direct the processor to operate in accordance with the present invention.

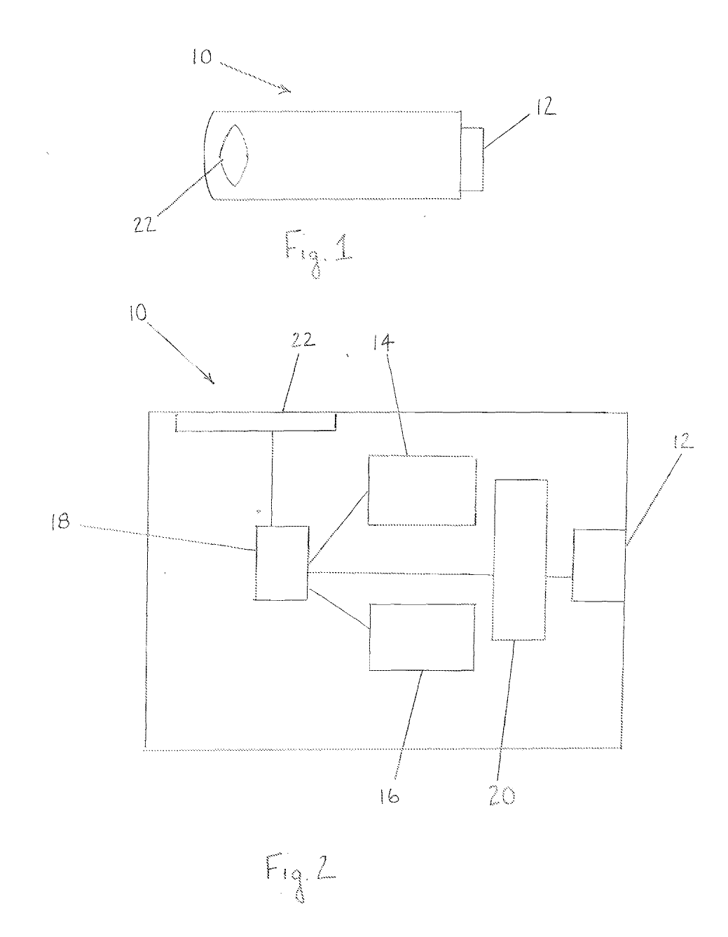

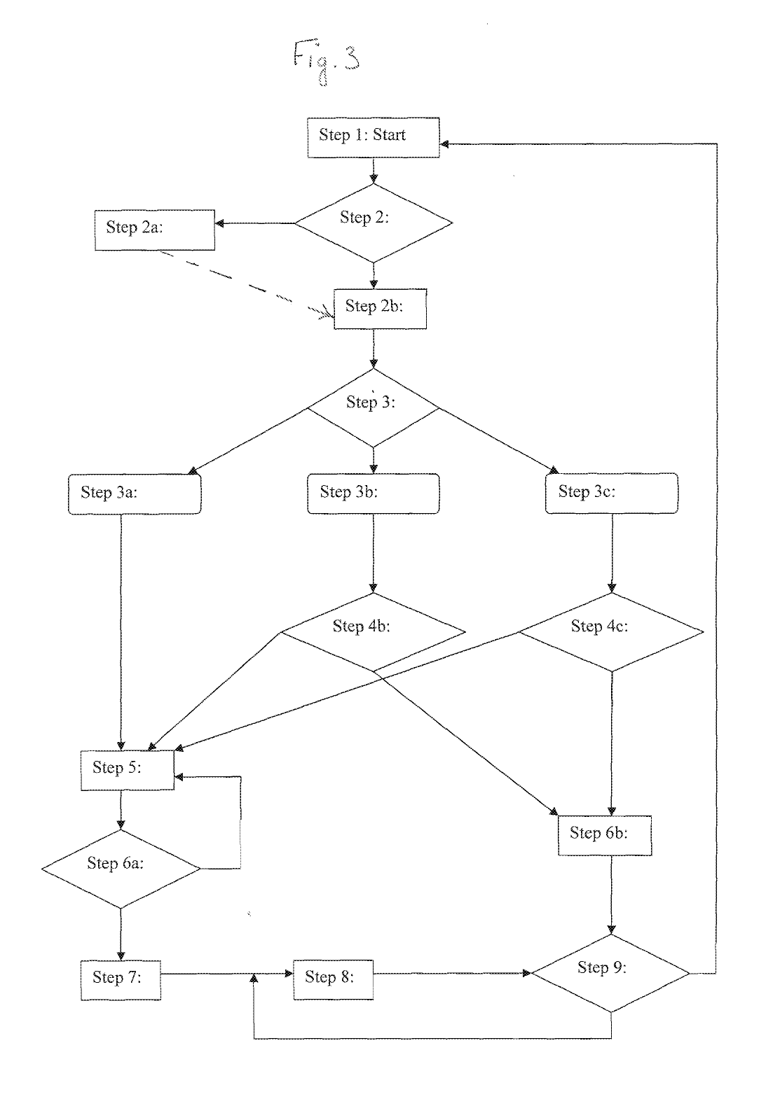

Accordingly, and in reference to FIGS. 1 and 2, the present invention is described in one embodiment by way of a general top view of an outer structure of a trip identification and recording storage media device 10 and of a general diagram of the electrical components of the recording media device 10 as an example of the present invention. FIG. 1 describes one embodiment having a portable key shape similar to traditional flash drive configurations. The device 10 includes an interface element 12, and in some embodiments a USB port, a location recording element 14, a voice recording element 16, control circuitry 18, and a storage media 20. The location recording element in preferred embodiments is a GPS recording element, but may in other embodiments comprise location recording technology known to one skilled in the art. The storage media may comprise a storage device such as an integrated circuit, flash memory, flash drive, or other portable memory as known in the art. The device may store application software and other instruction on the storage media for functionality as further described below and that may be used in combination with a CPU or other computer. The control circuitry 18 is in electrical communication with a user interface 22, in some embodiments a functional control such as a button and potentially further including a display or other control function indicator, as well as recording element 14, voice recording element 16, and a storage media 20, as described in FIG. 2 and as would be understood by one skilled in the art.

The control circuitry 18 in preferred embodiments is not a CPU, computer microprocessor, or other data processing device, although those skilled in the art will appreciate that the control circuitry is designed to simply facilitate the recording and storage of information from the voice recording element 16 and location recording element 14 on to the storage media 20. The control circuitry does not execute operating system software and application software from the storage media 20; however, independent processing means, such as an independent CPU or computer, may retrieve and execute operating system software and application software from the storage media 20 in order to further retrieve and process travel information as further described and as part of the present invention. Operating system software may comprise an operating system, utilities, drivers, networking software, and other software typically loaded onto a general-purpose computer. Application software could comprise an application program, firmware, or some other form of machine-readable processing instructions in order to facilitate retrieval and use of the travel information.

The control circuitry 18 could comprise a communication device, such as a wireless modem, Bluetooth technology, or other remote communication technology as understood by one skilled in the art. The user interface 22 could comprise one or more buttons, including or in the alternative a voice recognition interface, graphical display, touch screen, or some other type of user device.

The device may feature auto-install functionality, wherein the recording media device is connected with a USB port of a computer and allowing the computer to install stored software applications or other instruction on to the computer in order to allow the computer to retrieve and process travel information. In still other embodiments, portals having media connection to and from the device, such as by way of the connected computer or by way of a communication device of control circuitry 18, for access to the internet provide for retrieval and processing of travel information remotely, such as via the internet and web-based applications. Once the software or other instruction is installed the application in some embodiments may remove the install software or other instruction from the device to leave more room for travel information.

Accordingly, in one embodiment of the present invention, the recording media device has the functionality of a GPS recorder and voice recorder with the operational option to turn the location recording element 14, in some embodiments a GPS recording element, and voice recording element 16 on and off depending on usage. The user, for example a business person, using a vehicle may not always use the vehicle for business purposes and will have need to turn on and off the recording media device. So the device, for example, may have “record trip” functionality that can be turned on if the vehicle is used for business, off if used for private use.

The voice recording element 16 may comprise a microphone and recording circuitry as is known in the art of pocket voice recorders. The voice recording element 16 provides functionality to the recording media device for recording and storing sounds or voice, such as descriptive messages about the trip. Although referred to as a voice recording element, the element also provides the capacity to record any sound as understood by those skilled in the art. The device may also be powered by power adapters or other devices designed to provide mobile power to electronic devices, such as power adapters for inside a vehicle, or in some embodiments via USB connection to a device.

The recording devices and methods disclosed allow a user to make a voice recording in association with travel, such as a business trip driven in a vehicle, while providing trip-specific control functionality of the recording. The current location of the user, corresponding in some embodiments to the location of the vehicle, is determined by the GPS recording element. The device may be operated on and off to record particular trips, for example business trips, that may also depend upon the further requirements of the user. Voice recording is also provided for recording and storing messages of the user that may relate to the trip.

Once downloaded the travel information may be displayed with links to the voice recording, as well as other trip specific information such as internet links to maps, and text may be added to further describe trip information. In some embodiments, the invention is a media device providing for USB connectivity and may further be configured in a key format.

Methods such as those corresponding to the devices are also disclosed, as are devices corresponding to the methods, as well as methods of doing business. Removable and portable trip recording media devices and methods are disclosed, having features not dependent upon a CPU or a navigational system, as previously described, in providing functionality for recording trip information, such as location information or voice information. In some preferred embodiments both location information and voice information may be recorded and stored, as well as control of the recording. Other features are the on and off functionality of the invention and further in association with the recording of voice information. In preferred embodiments the invention is not dependent upon the recording of way points of any particular route in recording location and voice information.

Furthermore, trip identification and recording devices and methods are disclosed, again having features not dependent upon a CPU or a navigational system in providing functionality for recording location or voice information, as well as in the display of trip information and with links to the voice recording, as well as other trip specific information such as internet links to maps and text that further describe trip information. In some preferred embodiments both voice information and location information may be recorded and stored, as well as control of the recording. Other features are the on and off functionality of the invention and further in association with the recording of voice information. In preferred embodiments the invention is not dependent upon the recording of way points of any particular route in recording location and voice information. Other features are disclosed as embodiments of the invention.

Accordingly, in one embodiment, and in general reference to FIGS. 2 and 3, the invention may have in some preferred embodiments three modes of operation or more. A first mode of operation may comprise the functional option of record everything, potentially referred to in acronym as part of the device and method as ‘re’, wherein all location information is recorded. A second mode of operation may comprise the functional option of recording only trips when the user interface 22, and in some embodiments a “record” button, is selected, potentially referred to in acronym as part of the device and method as ‘rp’. A third mode of operation may comprise the functional option of not recording or skip recording, potentially referred to in acronym as part of the device and process as ‘rs’, when the user interface 22, and in some embodiments the “record” button, is selected. The invention may be set to a particular mode by the user through the user interface 22 and by way of the control circuitry 18. In this broad concept of allowing on and off recording capability the present invention excels over previous efforts.

In some preferred embodiments an automatic voice record feature is provided in the ‘re’ and ‘rs’ modes. In one embodiment, a set amount of voice recording, say for example 10 seconds of voice, is recorded at the beginning of recording, and in some embodiments when the vehicle is in motion, and in the instance of ‘rs’ mode, when recording is initiated or renewed. In the ‘rp’ mode the voice recording begins when the user interface 22, and in some embodiments a “record” button, is pushed. For longer voice recording the “record” button can be held down or otherwise activated and voice is recorded until the user interface 22 is selected to not record, such as in some embodiments when the “record” button is deselected (such as when the button is released from recording).

Furthermore, after recording, the recording device may be combined with a CPU or computer to provide a trip identification and recording system. Accordingly, the location information files recorded by the GPS recording element 14 may be automatically downloaded to a software application associated with the CPU or computer, such as may be downloaded from the storage media 20 once the recording device is in communication with the CPU or computer, direct or remote, and in some embodiments when the recording device is inserted in to the USB port. The software application in accordance with the present invention as a trip identification and recording system, will display the trips with links to the voice recording, and may even further combine other trip information such as links to electronic maps from the internet or other source, including preloaded trip information on the storage media 20, whereby the travel information is subsequently visualized by the user. The software application may further allow the user to update, add or delete text fields on the corresponding maps for comments or other notation.

Another function may be provided wherein, in some embodiments, a same trip feature is performed. In some preferred embodiments, a restart is performed each instance the user stops the vehicle, wherein the device may or may not be powered or powered off, and the user subsequently selects a “same trip” function to continue on the previous trip recording. Further functionality is provided wherein recording may be reset, allowing in some applications the user to reset recording for any reason, such as to record a new trip without stopping or powering off the device, and a new recording may be made including a new sounding recording.

Again in reference to FIG. 3, one embodiment of the invention comprises the following functional sequence as both device and method. In a first step 1 the recording device is provided power and starts operation. It is at this point that the user may select an operation mode. In other embodiments, the operation mode can only be selected with the device not powered on. The control circuitry 18 checks the input voltage 2 and if the input voltage is at or about 5 V, step 2a, the unit operates as further described below. Alternatively, in other embodiments, control circuitry 18 checks the input voltage 2 and if the input voltage is at or about 5 V, step 2a, the unit operates in a “USB-drive-mode” and is prepared for data processing device or other access of travel information on the storage media element, reducing the need for location recording. If the input is at or about 12 V the unit operates in a “GPS recorder mode”, step 2b. As described above, some embodiments may also operate in “GPS recorder mode” even if the input voltage is at or about 5 V. Furthermore, the voice recording may be available in either mode.

In either power mode, the GPS recording element 14 starts recording location information and the information is stored on storage media 20 with an assigned identification for the trip, an identification that will be assigned to a corresponding sound file as further described below. The control circuitry 18 then determines in step 3 which operation mode has been selected.

If the operation is in ‘re’ mode 3a, an audible sound such as a beep may be given in some embodiments to indicate that the device is ready and recording.

If the operation mode is in ‘rs’ mode 3b, and in some embodiments when the user interface 22, such as a record button, is pressed in less than a prescribe amount of time, determined in step 4b, then no recording is provided by the device and location information is discarded in step 6b. This allows for unnecessary travel information to be removed from the device, step 6b, and preserving storage capacity. In some particular embodiments, recording will begin in ‘rs’ mode if the user interface 22 is not activated in a prescribed amount of time, determined in step 4b, and recording in step 5, still allowing an option for recording by the user in the ‘rs’ mode. In this context the particular embodiment of the recording button or selection may be considered a do-not-record selection. In one application, for example, a majority of a user's trip may not require recording, but for a last portion or in order for the user to change their mind to record travel information. The user would activate user interface 22 within the prescribed time. Later, at the last portion of the travel, the user may again activate user interface 22 to begin recording as determined in step 4b. In the ‘rs’ mode, an audible sound such as a beep will indicate the device is ready and is recording, unless of course the user interface 22, in some embodiments a record button, is appropriately selected to not record, such as in the embodiment just described.

In a third mode 3c, in some embodiments the ‘rp’ mode, an audible sound such as a beep will indicate the device is ready and recording will begin when the user interface 22 is so activated, such as when the record button is selected as previously described, as determined in 4c, resulting in recording at step 5. If the user interface is not activated, then no recording is provided by the device and location information is discarded in step 6b. This allows for unnecessary travel information to be removed from the device, step 6b, and preserving storage capacity. In one application, a user may understand that only one or more portions of the trip would require recording, thus activating user interface 22 only during the start of that portion or portions of the trip and recording at step 5.

As previously mentioned, recording of sound will begin at step 5, and in some embodiments, for a prescribed amount of time by way of the voice recording element 16. Further, and in some embodiments, if after the prescribed amount of time the user interface 22 remains activated, such as remaining selected or depressed by the user, as determined in step 6a, voice recording continues at step 5 for the prescribed amount of time, allowing additional voice information to be recorded. As previously mentioned, any sound information and location information is discarded and that portion of the trip is not recorded at step 6b.

Furthermore, after recording has occurred at step 5, the device stores the voice and other sound information step 7 as a trip file that is associated with the trip identifier and location information so recorded. In this process the recording of location information will continue and will be stored as part of the trip file in step 8. In some embodiments, recording of location information may be discontinued if, for example, the vehicle does not move for a predetermined amount of time, as may be determined from the location information. Furthermore, discontinued recording may occur through further functionality of the user interface 22 to end the recording.

Furthermore, at step 9, the device determines recording should be renewed if discontinued in step 8. In one embodiment, the recording of location information may be continued if, for example, the vehicle moves, say for a predetermined amount of time, as may be determined from the location information. Furthermore, continued recording may occur through further functionality of the user interface 22 to renew the recording, such as further described below. In one application, continued location information will be recorded in association with the same travel information file, allowing for the same trip to be continued in recording. In step 9, if there is no previous trip information or if a new trip is to be recorded, the device begins a new recording of travel information and the process is repeated.

In one embodiment of the present invention, separate functionality may be provided by the user interface 22. In this regard, the user interface may comprise one or more elements such as interfaces, buttons or other selection means. In one embodiment, two interfaces may be provided, again represented as user interface 22. The first selection means, such as a first button, would function as previously described. A second button or other selection means may provide additional or supportive functionally as previously described. For example, the second interface may facilitate the selection of same or continued trip recording.

In same or continued trip recording, the device may restart each time the user stops the vehicle, such as when power is not supplied to the device. A user may then select the second interface, such as what may be referred to as the “same trip” button, if the user wants to continue recording on the previous trip as is determined in step 9. By way of example, in some embodiments, if the user were to stop, for example to refuel the vehicle, once the vehicle was restarted the user then selects “same trip” and the device will continue on the previous trip recording without rerecording further voice and sound information. Further enhancement may include the device beeping for “new trip” selection by the user. Also selecting both user interfaces at the same time may reset the recorder/recording, in some embodiments, so a “redo” or a new trip may be recorded without stopping or removing power to the device in order to reset. Further, in some embodiments, both user interfaces may be selected to restart the device and a new trip recording and 10 second sound recording will start.

Other embodiments of the present invention may be found as a combination of one or more features as previously described as embodiments of recording. Furthermore, embodiments of the present invention further comprise methods of doing business, and particularly, methods of accounting and recording travel information as previously described, wherein the travel information is so recorded as described above and wherein the travel information identifies those portions of the trip, or the entire trip, as related for a business purpose, such as in relation to per diem calculations, costs billed to clients, tax purposes, contract or vendor billing, accounts payable and receivable, quality control and review, and auditing.

As can be easily understood from the foregoing, the basic concepts of the present invention may be embodied in a variety of ways. It involves techniques as well as one or more apparatus, device and assembly, as well as devices, assemblages and several apparatus that may provide for the appropriate techniques. In this application, the techniques of the present invention in some embodiments are disclosed as part of the results shown to be achieved by the various devices, assemblages and several apparatus described and as steps that are inherent to utilization. They are simply the natural result of utilizing the devices, assemblages or several apparatus as intended and described. In addition, while some devices and apparatus are disclosed, it should be understood that these not only accomplish certain methods but also can be varied in a number of ways. Importantly, as to all of the foregoing, all of these embodiments are encompassed by this disclosure.

Further, each of the various elements or steps of the invention may also be achieved in a variety of manners. This disclosure should be understood to encompass each such variation, be it a variation of an apparatus embodiment, a method or process embodiment, or even merely a variation of any element of these. Particularly, it should be understood that as the disclosure relates to specific features of the invention, the words for each feature may be expressed by equivalent apparatus, device, assembly or method terms—even if only the function or result is the same. Such equivalent, broader, or even more generic terms should be considered to be disclosed for each element, step, or action. Such terms can be substituted where desired to make explicit the implicitly broad coverage to which this invention is entitled. As but one example, it should be understood that all actions or functions may be expressed as a means for taking that action or achieving that function, or as an element which causes that action or has that function. Similarly, each physical element disclosed should be understood to encompass a disclosure of the action or function which is facilitated by that physical element.

Any acts of law, statutes, regulations, or rules mentioned in this application for patent; or any patents, publications, or other references mentioned in this application for patent are hereby incorporated by reference. In addition, as to each term used it should be understood that unless its utilization in this application is inconsistent with such interpretation as would be understood by one of ordinary skill in the art from this disclosure, common dictionary definitions should be understood as incorporated for each term and all definitions, alternative terms, and synonyms such as contained in the Random House Webster's Unabridged Dictionary, second edition are hereby incorporated by reference. However, as to each of the above, to the extent that such references, information or statements incorporated by reference might be considered inconsistent with the patenting of the invention, such as contradicting disclosed features ascertained by a reading of these patent documents, such information and statements are expressly not to be considered incorporated by reference and more particularly as not made by the Applicant. Furthermore, as to any dictionary definition or other extrinsic evidence utilized to construe this disclosure, if more than one definition is consistent with the use of the words in the intrinsic record, the claim terms should be construed to encompass all such consistent meanings.

Furthermore, if or when used, the use of the transitional phrase “comprising” is used to maintain “open-end” disclosure herein, according to traditional disclosure and claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

I claim:

1. A trip identification and recording storage media device, comprising:
control circuitry;
a location recording element in communication with said control circuitry;
a voice recording element in communication with said control circuitry;
a user interface in communication with said control circuitry; and
storage media in communication with said control circuitry;
wherein travel information is recorded by said voice recording element and said location recording element and stored to said storage media and wherein travel information is stored to said storage media identified for a corresponding trip on said storage device.

2. A trip identification and recording storage media device as described in claim 1, wherein said travel information comprises voice and location information.

3. A trip identification and recording storage media device as described in claim 2, wherein said voice information comprises information recorded corresponding to said trip.

4. A trip identification and recording storage media device as described in claim 2, wherein said location information comprises information recorded corresponding to said trip.

5. A trip identification and recording storage media device as described in claim 3, wherein said voice information comprises description of said trip.

6. A trip identification and recording storage media device as described in claim 1, wherein said location recording element comprises a GPS recording element.

7. A trip identification and recording storage media device as described in claim 1, further comprising an interface element in communication with said storage media for communication with a data processing device.

8. A trip identification and recording storage media device as described in claim 7, wherein said interface element comprises a USB interface for communication with a USB-enabled device.

9. A trip identification and recording storage media device as described in claim 7, wherein said storage media device allows installation of applications or other instruction from said storage media to a data processing device to allow the data processing device to retrieve and process travel information.

10. A trip identification and recording storage media device as described in claim 1, wherein said storage media device allows a remote retrieval and processing of travel information.

11. A trip identification and recording storage media device as described in claim 1, wherein said control circuitry comprises a communication device.

12. A trip identification and recording storage media device as described in claim 1, wherein recording and storage of travel information may be stopped for a portion of said trip.

13. A trip identification and recording storage media device as described in claim 12, wherein recording and storage of travel information may be continued for a portion of said trip.

14. A trip identification and recording storage media device as described in claim 12, wherein recording and storage of travel information may be stopped for a portion of said trip without removing power to said recording media device.

15. A method of trip identification and recording travel information, comprising the steps of:
providing a storage media device;
recording travel information with said media device;
identifying said recorded travel information to a trip; and
storing said travel information identified to a trip to a storage media element of said storage media device;
wherein said travel information comprises voice information and location information.

16. A method of trip identification and recording travel information as described in claim 15, wherein said step of recording travel information comprises recording voice information descriptive of said trip.

17. A method of trip identification and recording travel information as described in claim 15, further comprising the step of stopping recording and storage of travel information for a portion of said trip.

18. A trip identification and recording storage media device as described in claim 17, further comprising the step of continuing recording and storage of travel information for a portion of said trip.

19. A trip identification and recording storage media device as described in claim 17, wherein said step of stopping recording and storage of travel information for a portion of said trip does not require removing power to said recording media device.

20. A method of accounting and recording travel information, comprising the steps of:
providing a storage media device;
recording travel information with said media device;
identifying said recorded travel information to a trip for a business purpose;
storing said travel information identified to a trip to a storage media element of said storage media device; and
accessing and processing said travel information for said business purpose;
wherein said travel information comprises voice information and location information.
